(19) United States
(12) Patent Application Publication
(10) Pub. No.: US 2005/0084434 A1
(43) Pub. Date: Apr. 21, 2005

(54) Scrubbing systems and methods for coal fired combustion units

(75) Inventors: Craig E. Cox, Fruit Heights, UT (US); Michael A. Hendrickson, Woodinville, WA (US); Mark Hennenfent, San Diego, CA (US)

Correspondence Address: Attn: M. Wayne Western;THORPE NORTH & WESTERN, LLP, P.O. Box 1219, Sandy, UT, 84091-1219, US

(73) Assignee: Enviroserve Associates, L.L.C.

(21) Appl. No.: 10/938,124

(22) Filed: Sep. 10, 2004

Related U.S. Application Data
(63) Continuation-in-part of application No. 10/690,219, filed on Oct. 20, 2003.

(51) Int. Cl. B01D 53/56; F23J 11/00

(52) U.S. Cl. 423/235; 422/171

(57) ABSTRACT

Systems and methods for removing toxic emissions from flue gas of coal fired combustions units can be achieved. Decreasing nitrogen oxide and sulfur emissions from a coal fired circulating fluidized bed reactor can include treating flue gas using a selective catalytic reduction system and a wet scrubber. Furthermore, reducing the nitrogen oxide emissions from a pulverized coal reactor can be accomplished with a selective non-catalytic reduction system. Additionally, the reduction of sulfur oxide emissions from a pulverized coal reactor can be enhanced using dry and/or wet scrubbers. Such systems and methods provide improved levels of toxic emissions over currently available technologies.

### PRIORITY DATA

This patent application is a continuation-in-part of U.S. patent application Ser. No. 10/690,219 filed Oct. 20, 2003, which is incorporated herein by reference in its entirety.

### FIELD OF THE INVENTION

The present invention relates generally to systems and methods for reducing emissions from coal fired combustion units. More particularly, the present invention relates to using selective catalytic and non-catalytic reduction systems to reduce nitrogen oxide emissions.

### BACKGROUND OF THE INVENTION

Coal fired combustion currently accounts for approximately 50% of electricity production in the United States. Domestic coal combustion for electricity production consumes almost one billion tons of coal annually, and this number is steadily increasing. Early coal fired power plants utilized minimal emission control systems and were generally limited to particulate control. The Clean Air Act of 1970, amended in 1977 and 1990, has heightened awareness and increased reduction of a variety of pollutants.

Currently, coal fired combustion systems generally range from older pulverized coal (PC) systems, e.g., down-fired, wall-fired, cyclone-fired, and tangentially-fired, and stoker fired boilers to newer bubbling fluidized bed (BFB) and circulating fluidized bed (CFB) reactors. Typical emissions control systems of both PC and CFB units can include particulate control systems, often followed by an SO₂ control system. A wide variety of additional units can also be used to control various pollutants and/or facilitate recycle or recovery of heat and other resources. Reduction of toxic emissions can also be enhanced through a careful control of the combustion process.

Typical CFB reactors include a limestone injection system followed by a particulate collection system for the reduction of particulate emissions. One benefit of CFB reactors is that sulfur oxide emissions can be reduced within the reactor by controlling the amount of limestone added during combustion. In a few instances, CFB reactors have also included a dry scrubber at the outlet of the particulate collection system to further enhance sulfur dioxide emissions. For these and other reasons, CFB reactors make up the vast majority of coal fired combustion units built over the past couple of decades. Older PC units typically produce higher levels of toxic emissions than CFB reactors. Some of these PC units have been retrofitted to include a variety of emission control systems. Typically, these retrofitted PC units include a particulate collection system and sometimes also include a wet scrubber, although in some cases a dry scrubber can be used.

Due at least in part to the availability of coal and steady political and economic pressures to reduce emissions, coal fired combustion has seen dramatic improvements in toxic emissions in recent years. Unfortunately, emissions from coal fired combustion units still accounts for a large percentage of total toxic emissions such as sulfur oxides, nitrogen oxides, and a variety of other potentially harmful substances. It would therefore be a significant advancement and contribution to the art to provide systems and methods which offer a simple, economic, and effective way of further decreasing toxic emissions from coal fired combustion units over current technologies.

### SUMMARY OF THE INVENTION

While many methods for removing toxic emissions and other unwanted contaminants have been developed, there remains the need for improved methods which make coal based combustion units a more attractive source of electricity through significantly reduced emissions and improved ability to take advantage of government tax credits and incentives. In particular, it is desired to develop a system and method to reduce the nitrogen oxide and sulfur oxide emissions in a flue gas. The present invention relates to the treatment of flue gasses from a coal fired combustion unit using a selective catalytic or non-catalytic reduction system to reduce the nitrogen oxide emissions.

In one aspect of the present invention, a system for treatment of flue gas from a coal fired circulating fluidized bed reactor can include a selective catalytic reduction (SCR) system connected to the circulating fluidized bed. The SCR system can reduce the nitrogen oxide compounds in the flue gas to produce a low nitrogen oxide flue gas. A wet scrubber can also be connected to the SCR to treat the low nitrogen oxide flue gas to reduce sulfur oxides. Wet scrubbers suitable for use can include gas phase scrubbers, liquid phase scrubbers, and combinations of these scrubbers.

In yet another detailed aspect of the present invention, additional units can be added to the system to remove specific contaminants. In one embodiment, a mercury removal device can be operatively connected to one of several possible locations depending on the type of system developed. Currently, there are three broad categories of mercury removal technologies under development which include converting the mercury into a solid which then can be removed with either a particulate control device or wet scrubber; adsorption of mercury on some type of material injected into the gas stream which again would then be removed by either a particulate control device or wet scrubber; and converting mercury into a soluble form with injection of reagents which would then be removed by a wet scrubber. Depending on the type of mercury removal system chosen, the injection of materials or reagents would occur in several possible locations including upstream of a selective catalytic reduction (SCR) unit, electrostatic precipitator (ESP), baghouse, or wet scrubber.

In still another embodiment of the present invention, the system for the treatment of flue gas can be from a pulverized coal (PC) reactor can include a selective non-catalytic reduction (SNCR) system operatively connected to the PC reactor and configured to reduce nitrogen oxide gases in the flue gas to produce a low nitrogen oxide flue gas.

In yet another aspect of the present invention, the system for the treatment of flue gas can be from a PC reactor can include an SNCR system operatively connected to the PC reactor and an SCR operatively connected to the SNCR system both being configured to reduce nitrogen oxide gases in the flue gas to produce a low nitrogen oxide flue gas.

In still another aspect of the present invention, the system for treatment of flue gas can be adapted to reduce nitrogen oxide emissions by from about 50% to about 100%, and preferably from about 97% to about 100%. For systems used in connection with a CFB reactor, nitrous oxide emissions can be reduced to a level of from about 2 ppm to about 5 ppm. Emissions from PC reactors can also be dramatically improved and are typically slightly lower percentage reductions (higher ppm) than achievable when using CFB reactors.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a schematic illustration of one embodiment in accordance with the present invention including a CFB reactor and an SCR;

FIG. 2 is a schematic illustration of another embodiment in accordance with the present invention including a PC reactor and an SNCR;

FIG. 3 is a schematic illustration of one embodiment in accordance with the present invention including a CFB reactor and wet scrubber; and

FIG. 4 is a schematic illustration of another embodiment in accordance with the present invention including two sequential wet scrubbers.

### DETAILED DESCRIPTION

For the purposes of promoting an understanding of the principles of the invention, reference will now be made to exemplary embodiments, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

### DEFINITIONS

In describing and claiming the present invention, the following terminology will be used.

The singular forms “a,” “an,” and “the” include plural referents unless the context clearly dictates otherwise. Thus, for example, reference to “a toxic material” includes reference to one or more of such materials, and reference to “a treatment step” includes reference to one or more of such steps.

As used herein, “dry scrubber” refers to a flue gas treatment apparatus which produces a dry waste product and a treated gas. Some dry scrubbers can involve wet reactants and/or processes which are dried prior to removal from the apparatus, such as spray dryer absorbers, flash dryer absorbers, and circulating dry scrubbers.

As used herein, “wet scrubber” refers to a flue gas treatment apparatus which produces a wet waste product and a treated gas. Although, wet and dry scrubbers can be used for primary particulate removal, in context of the present invention, the use of the terms “wet scrubber” and “dry scrubber” refer to flue gas desulfurization units rather than primary particulate removal unless specifically stated otherwise. Wet scrubbers can be used to remove sulfur oxides and particulates from a flue gas. A wide variety of wet scrubber configurations are known and can involve contacting the flue gas with a sprayed liquid, forcing the flue gas through a volume of liquid, and other similar methods.

As used herein, “primary particulate removal” refers to initial removal of a large portion of particulates from a flue gas. This particulate removal is typically a separate unit such as a baghouse, electrostatic precipitator, or other scrubbing device; however such can also be integrated into the coal fired combustion unit. It will be understood that later scrubbing or polishing steps can, and usually do, remove particulates not removed by the primary particulate removal step.

As used herein, the term “selective catalytic reduction” or “SCR” refers to any system or device that removes or reduces nitrogen oxide gases with a catalyst. Currently, the most common SCR unit includes a catalyst bed with an accompanying upstream ammonia or urea injection point. As the flue gas passes over the catalyst bed in the presence of ammonia, a series of chemical reactions reduce the nitrogen oxides to predominantly nitrogen and water.

As used herein, the term “selective non-catalytic reduction” or “SNCR” refers to any system or device that removes or reduces nitrogen oxide gases without the aid of a catalyst. The most common type of SNCR system involves injection of ammonia or urea into the flue gas. However, the term SNCR, as used herein can refer to other systems or units which accomplish nitrogen oxide reduction without the use of a catalyst, e.g., new sorbents or reagents which effect a chemical change and/or make a nitrogen species more soluble in water. In combination with the sorbents or reagents, these systems often also utilize separators such as wet ESP, scrubber, baghouse, or the like. As such, the terms SCR and SNCR collectively include all units, systems, materials, or the like which treat flue gases subsequent to combustion.

As used herein, the term “between” is used herein to identify a range and without the modifier “about” does not include the limit of the identified range. For example, “between 95% and about 100%” includes values ranging from about 100%, as would be understood in the art down to, but not including 95%. Further, a concentration range of “about 1% to about 4.5%” should be interpreted to include not only the explicitly recited concentration limits of 1% to about 4.5%, but also to include individual concentrations such as 2%, 3%, 4%, and sub-ranges such as 1% to 3%, 2% to 4%, etc. The same principle applies to ranges reciting only one numerical value, such as “less than about 4.5%,” which should be interpreted to include all of the above-recited values and ranges. Further, such an interpretation should apply regardless of the breadth of the range or the characteristic being described.

### THE INVENTION

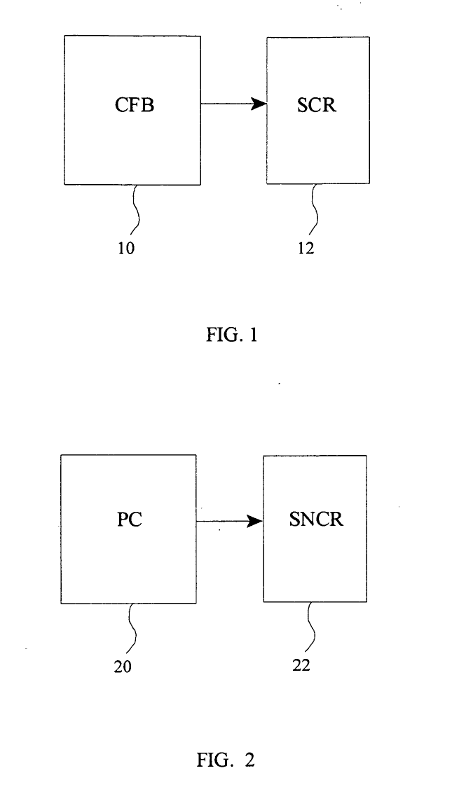

In one aspect, the present invention includes a system for treatment of flue gas from a coal fired circulating fluidized bed (CFB) reactor. Referring to FIG. 1, a CFB reactor 10 can be operatively connected to a selective catalytic reduction (SCR) system 12. The SCR systems of the present invention are configured to reduce the amount of nitrogen oxide in the flue gas, thus producing a low nitrogen flue gas. The present invention can optionally include a wet scrubber operatively connected to the SCR system. The wet scrubber is configured to reduce the sulfur oxide in the flue gas, thus creating a low sulfur flue gas.

Traditionally, many treat flue gas with an SCR system which can be adapted to reduce nitrogen oxide emissions for a pulverized coal (PC) units or a selective non-catalytic reduction (SNCR) for CFB units. FIG. 2 illustrates a PC reactor 20 operatively connected to an SNCR system 22. The SNCR system 22 can be configured to reduce nitrogen oxide in the flue gas to produce a low nitrogen oxide flue gas. An SCR system can optionally be operatively connected to the SNCR system to further reduce the nitrogen oxide emissions in the low nitrogen oxide flue gas to obtain an even lower nitrogen oxide flue gas. The current embodiment of the present invention can further include a dry scrubber operatively connected to the SNCR or SCR systems which can be adapted to reduce the sulfur oxide emissions to produce a low sulfur oxide flue gas. In yet another aspect of the present invention, a wet scrubber can operatively be connected to the dry scrubber to further reduce the sulfur oxide emissions to obtain a lower sulfur oxide flue gas.

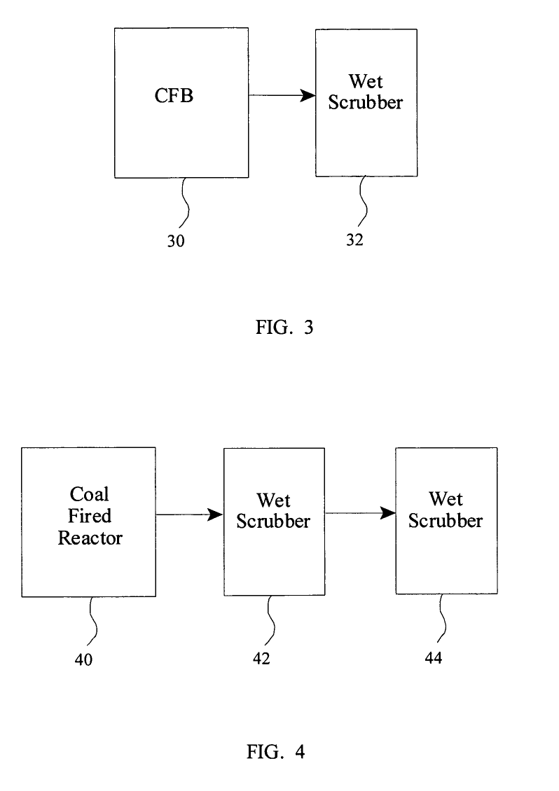

In another aspect, the present invention includes a system for treatment of flue gas from a coal fired circulating fluidized bed (CFB) reactor. Referring now to FIG. 3, a CFB reactor 30 can be operatively connected to a wet scrubber 32. The CFB reactors of the present invention can include any known configuration of fluidized bed reactors used for burning coal. A wide variety of specific configurations and devices can be used in connection with CFB reactors and such are known to those skilled in the art. Generally, CFB reactors involve injecting a coal based fuel and a sorbent into a stream of fluidizing air in a combustion chamber. Under turbulent conditions, the fuel is at least partially burned. The sorbent is most often limestone, however other sorbents are known to those skilled in the art such as lime, single and dual alkalides, magnesium oxide, sodium carbonate, sodium bicarbonate, sodium hydroxide, sodium sulfite, sodium bisulfite, and mixtures of these materials. Sulfur in the fuel can react with oxygen to form sulfur oxides in the combustion chamber. The sorbent can then react with the sulfur oxides to produce solid materials such as calcium sulfate or gypsum, which can then be removed and disposed of. Further, various additives can also be added to improve sulfur oxide removal or combustion efficiency. Typical CFB reactors can provide from about 80% to about 95% sulfur oxide reduction, depending on the coal composition and the sorbent efficiency and flow rate. Unburned fuel, limestone, and ash can then be recovered, e.g. via a hot cyclone or the like, and recycled to the combustion chamber or removed.

Heat generated from combustion of the fuel in a CFB is typically used in production of electricity, however CFB reactors can also be used in other applications known to those skilled in the art and such are considered within the scope of the present invention. Further, the fuel will typically include crushed coal, however any number of hydrocarbon containing materials can also be used. Suitable crushed coal include almost any available coal types such as, but not limited to, lignite, bituminous, sub-bituminous, anthracite, and various waste coals including anthracite culm and silt and bituminous gob. In accordance with the present invention, additional fuel materials can be added to the crushed coal. Suitable additional fuel materials can include, without limitation, petroleum coke, shredded tires, biomass, oil, natural gas, bagasse, and any other hydrocarbon-containing material having a useful heat value. These additional fuel materials can often comprise up to about 25% of the fuel composition. However, when using CFB reactors, the fuel can comprise or consist essentially of these additional fuels. For example, coal can be substituted with oil, natural gas, biomass, or the like.

Flue gas from the CFB reactor can then be directed toward a particulate collection system to produce a low particulate flue gas. Suitable particulate collection systems can include baghouses, electrostatic precipitators, multiclones, venturi scrubbers, or any other systems which are capable of removing a majority of particulates from the flue gas. In one detailed aspect of the present invention, the particulate collection system can collect from about 60% to about 99% of particulates ranging from about 0.01 μm to several hundred micrometers. In accordance with another detailed aspect of the present invention, the particulate collection system can collect from about 98% to about 100% of particulates. Particulate collection systems can be separate from the CFB reactor or integrated therewith. In one aspect of the present invention, the particulate collection system can be a wet scrubber operatively connected to the CFB reactor.

In accordance with the present invention, a wet scrubber 32 can be operatively connected to the CFB 30. Alternatively, if a particulate collection system is present, the wet scrubber can be operatively connected to the particulate collection system. The wet scrubber can be configured to treat the flue gas to reduce sulfur oxides and other toxic emissions. Removal of at least a significant portion of the particulates from the flue gas prior to the wet scrubber significantly reduces the load of solids into the scrubber and thereby reduces or eliminates clogging. Further, one aspect of the invention is to significantly reduce sulfur oxide emissions, which goal is tempered by excessive particulates in the flue gas. As mentioned above, wet scrubbers can also act to remove particulates, even as a primary particulate collection system. However, in accordance with one aspect of the present invention, it is preferred that flue gas entering the wet scrubber is a low particulate containing flue gas.

Wet scrubbers suitable for use in the present invention can include gas phase scrubbers, liquid phase scrubbers, and combinations thereof. In one embodiment of the present invention, the wet scrubber is a liquid phase scrubber. Suitable liquid phase scrubbers include, without limitation, spray tower scrubbers including countercurrent, cocurrent, and crosscurrent designs, jet venturi scrubbers, and the like. In one detailed aspect, the liquid phase scrubber can be a spray tower scrubber. Suitable gas phase scrubbers include, without limitation, venturi scrubbers, e.g., fixed throat, variable throat, and adjustable throat designs; plate tower scrubbers, e.g., sieve, impingement, bubble-cap, and valve designs; orifice scrubbers, e.g., self-induced spray, inertial, and submerged orifice designs; and the like. Suitable combination liquid-gas phase scrubbers include, without limitation, wet film scrubbers, packed tower scrubbers, cyclonic spray scrubbers, mobile or moving bed scrubbers such as flooded bed and turbulent contact absorbers, baffle spray scrubber, mechanically aided scrubbers such as centrifugal fan and induced spray scrubbers, and the like. From the above discussion, it is evident that at least one aspect of the present invention lies in the discovery that flue gasses from circulating fluidized bed reactors (CFBs) can be treated with wet scrubbers to remove and/or reduce emissions and not in the discovery of any specific wet scrubber. Those skilled in the art will recognize a variety of wet scrubbers which can be used and such are considered within the scope of the present invention. Further, specific wet scrubber designs not yet commercially available are also considered within the scope of the present invention. Currently, liquid phase scrubbers are the most preferred for removal of sulfur oxides and other toxic emissions. Further, it is noted that, as a general rule, wet scrubbers are more efficient at sulfur oxide reduction than dry scrubbers.

In one alternative embodiment, the wet scrubber can be retrofitted to an existing CFB reactor including a particulate collection system. In one aspect of this alternative embodiment, the wet scrubber can be operatively connected to the outlet of an existing dry scrubber. The dry scrubber can be any existing or known dry scrubber such as, but not limited to, spray dryer absorber, flash dryer absorber, dry sorbent injector, circulating dry scrubber, fluidized bed absorber, and combinations thereof. In one embodiment of the present invention, the dry scrubber can be a spray dryer absorber or flash dryer absorber.

In another aspect of this alternative embodiment, the wet scrubber can be used as a replacement for an existing dry scrubber. A number of considerations can be important in fitting a wet scrubber to an existing plant. These considerations include, among others, compensating for the additional head loss, e.g., with an additional induced draft (ID) fan or alteration of an existing ID fan; addition of systems to accommodate wet waste product from the wet scrubber, e.g., ash handling system; recycle or provision of additional sorbent for sulfur oxide removal; addition to and modification of electrical and control systems; and other such considerations. Of course, the above discussion of retrofitting existing CFB reactors can also be applied to the design of an emission control system for a new CFB reactor.

In one alternative embodiment, the particulate control system can be a wet scrubber. In one detailed aspect, the wet scrubber can be a venturi scrubber. Flue gas exiting the CFB reactor can be directed to the wet scrubber. In this case, the wet scrubber is acting primarily as a particulate removal system. Flue gas exiting the wet scrubber can then be directed toward a second wet scrubber for further reduction of toxic emissions, particularly sulfur oxides.

In accordance with the present invention, the addition of a wet scrubber to a CFB reactor allows for improved usage of sorbent such as limestone and lime. For example, overall consumption of sorbent can be optimized with sulfur oxide removal. This entails adjusting the amount of sorbent used in the CFB reactor versus the amount of sorbent used in the wet scrubber. Further, in one aspect of the present invention, ash and unused sorbent recovered from the CFB reactor can be used in operation of the wet scrubber. CFB reactors can remove a significant portion of sulfur oxides, however much of the sorbent remains unused. Frequently, unused sorbent can comprise anywhere from 25% to over 50% of the solids removed from the particulate collection system and/or combustion chamber. Thus, the removed solids can be used to supplement the sorbent feed to the wet scrubber. Ash and gypsum in the removed solids can potentially present problems for the wet scrubber in terms of potential pluggage, erosion, etc. However, such a recycle of unused sorbent can reduce the operating costs by reducing overall sorbent consumption.

In addition, incorporating a wet scrubber with a CFB reactor provides the additional benefit in that the waste product such as gypsum produced from the wet scrubber is much more pure than from a CFB reactor alone. This higher quality waste product can be more easily sold as a byproduct. Therefore, in one aspect, the percentage of overall sulfur oxide reduction can be shifted towards the wet scrubber to offset ash disposal costs and overall sorbent usage.

The following discussion relates to reduction of toxic emissions. It will be understood that, in the context of the present invention, it is difficult to generalize a quantitative measure of reduction. The removal efficiencies can depend largely on the composition of the fuel, and can also be affected by specific equipment, operating parameters, and other factors. For example, achieving a 99% sulfur oxide removal on a low sulfur coal, such as Utah coal, is much more challenging than achieving a 99% removal rate on a high sulfur coal, such as Eastern Bituminous coal. In either case, the systems and methods of the present invention can be adapted to reduce sulfur oxide emissions by from about 95% to about 100%, and in another embodiment can reduce sulfur oxide emissions by from about 99% to about 100%. In another aspect of the present invention, the sulfur oxide emissions can be reduced to a level of from about 2 ppm to about 22 ppm, with from about 2 ppm to about 5 ppm being a preferred range. Those skilled in the art will recognize that the specific coal used can greatly influence the amount of sulfur oxides and other contaminants in the flue gas. As a result, the removal of sulfur oxides and other contaminants can be more difficult when using low sulfur or low-grade coal as the primary fuel. For example, Utah coal has a relatively low sulfur concentration of about 0.5%, and a decrease in sulfur oxide emissions of 95% results in about an emission level of about 22 ppm. In contrast, for a 3% sulfur Eastern bituminous coal, a 95% reduction yields about 130 ppm and a 99.6% reduction yields about 10 ppm.

In yet another detailed aspect of the present invention, treatment of the flue gas can reduce toxic emissions in addition to sulfur oxides. Non-limiting examples of such toxic emissions include nitrogen oxides, carbon monoxide, arsenic, beryllium, cadmium, hydrochloric acid, chromium, cobalt, hafnium, lead, manganese, mercury, nickel, zinc, selenium, benzo(a)pyrene, and combinations thereof. In addition to sulfur oxide removal, various wet scrubbers can remove different toxic emissions to varying degrees. Thus, the choice of specific wet scrubbers can be tailored to affect a more complete removal of specific emissions. For example, wet scrubbers using a sorbent mix of lime and activated carbon can be used to reduce contaminants. Those skilled in the art can make such design choices based on the present invention as discussed herein.

In one embodiment of the present invention, a mercury removal device can be operatively connected to one of several locations depending on the types of system utilized. Currently, there are three broad categories of mercury removal technologies under development which include converting mercury into a solid which can then be removed with either a particulate control device or wet scrubber; adsorption of mercury on specific materials injected into the gas stream which can then be removed by either a particulate control device or wet scrubber; and converting mercury into a soluble form by injection of reagents which would then be removed by a wet scrubber. Such mercury removal systems can involve sorbent injection, particulate collection, catalyst or chemical additives, adsorbent units, and the like. In light of increasingly stringent environmental control regulations, improvements and developments in the area of mercury control are expected. Any such mercury removal system, whether currently known or yet to be developed can be used in connection with the systems of the present invention. Several non-limiting examples of current mercury removal systems include activated carbon injection, modified SCR/FGD systems, injection of partially combusted coal, silicate based adsorbents, flow over plated materials, halide combustions catalysts, and combinations of these technologies. Depending on the type of mercury removal system chosen, the injection of materials or reagents can occur in several possible locations including before or after an SCR, ESP or baghouse, wet scrubber, or can be a separate unit operatively connected to the system to treat the flue gas. An additional benefit of these systems is their ability to remove other heavy metals such as zinc, cadmium and lead. Most of the current mercury removal systems suitable for use in the present invention can remove 90% or more of mercury from the flue gas. Depending on the fuel composition, the total generated mercury at most plants ranges from about 5 to 16 μg/dscm (micrograms/dry standard cubic meter) of flue gas. A mercury removal system suitable for use in the present invention can preferably reduce mercury emissions to a level of from about 1 μg/dscm to about 2 μg/dscm.

In an additional alternative embodiment of the present invention, the flue gas can be treated to reduce nitrogen oxide emissions. A number of nitrogen oxide reduction systems and methods can be used in conjunction with the systems of the present invention. Typical CFB units operate at a relatively low temperature, and thus have inherently lower nitrogen oxide emissions compared to PC units. However, additional steps can be taken to further reduce nitrogen oxide. For example, nitrogen based adsorbent reagents such as ammonia or urea can be injected into a cyclone in what is typically referred to as selective non-catalytic reduction (SNCR). However, as various regulatory agencies impose increasingly stringent nitrogen oxide emission requirements, SNCR will likely prove insufficient as a means of reducing nitrogen oxide emissions. To address this issue, a second nitrogen oxide reduction system can be operatively connected to a CFB to reduce nitrogen oxide levels. In one example, an SCR system can be connected at the outlet of the boiler with a second nitrogen oxide reduction system connected downstream of the cyclone. Alternatively, the SNCR system can be replaced with a single, more effective SCR system. In accordance with the present invention, a CFB having an SCR operatively connected thereto can produce a low nitrogen oxide flue gas having about 65 to about 85 percent reduction of nitrogen oxide from the flue gas. The addition of an SNCR system can allow for further improvement such as from about 95 to about 99 percent reduction of nitrogen oxide from the flue gas.

Similarly, systems for treating flue gas from a PC unit can include a nitrogen oxide reduction system. One particularly effective nitrogen oxide reduction system is SCR. Similar to those of CFB units, emissions requirements for PC units will likely become increasingly stringent. Accordingly, a PC unit can also be fitted with a second nitrogen oxide reduction system. Such an embodiment can result in nitrogen oxide reductions from about 95 to about 99 percent from the flue gas. For example, an SNCR system, possibly having multiple injection points, can be connected upstream of an SCR system. As a general guideline, SNCR systems typically operate at higher temperatures, e.g., 1400° F. to 1650° F., than SCR systems which operate around temperatures of 700° F. to about 800° F. Alternatively, conventional or advanced low nitrogen oxide burners can be used in conjunction with an SNCR or SCR system. Both embodiments result in a significant decrease in nitrogen oxide emissions. Other nitrogen oxide reduction methods which are primarily combustion modifications can include overfire air, flue gas recirculation, natural gas reburning, multi-stage combustion, and advanced combustion control systems. Direct treatment of flue gas is typically more effective, but also often adds to capital and operating costs. Non-limiting examples of suitable nitrogen oxide reduction systems for flue gas treatments can include SCR, SNCR, hybrid SCR/SNCR, simultaneous SO₂/NOx removal systems, and other known or developed technologies.

Referring now to FIG. 4, a system is shown for treatment of flue gas from a coal fired reactor 40. In accordance with the present invention, a particulate collection apparatus can be operatively connected to the coal fired reactor and configured to produce a low particulate flue gas. As mentioned above, the particulate collection apparatus can be a separate unit or integrated into the coal fired reactor. A first wet scrubber 42 can be operatively connected to the particulate collection apparatus and configured for scrubbing the flue gas and producing a treated flue gas having reduced emissions. Further, a second wet scrubber 44 can be operatively connected to the first wet scrubber and configured for scrubbing the treated flue gas to produce a low sulfur oxide flue gas.

In one aspect of the present invention, the first and second wet scrubbers can be independently selected from gas phase scrubbers, liquid phase scrubbers, and combinations thereof. In another aspect of the present invention, the first and second wet scrubbers can each be a liquid phase scrubber. Most often, the first and second wet scrubbers will be of a different type and/or design. In one embodiment, the first wet scrubber can be a spray tower scrubber and the second wet scrubbers can be a mobile or moving bed scrubber. Similarly, depending on the composition of the fuel and the desired emission levels the first and second wet scrubbers can be independently selected from spray tower scrubber, venturi scrubber, plate tower scrubber, orifice scrubber, packed tower scrubber, wet film scrubber, cyclonic spray scrubber, mobile or moving bed absorber, baffle spray absorber, and combinations thereof.

In this aspect of the present invention, the coal fired reactor can be any known coal fired reactor. In one embodiment, the coal fired reactor can be a circulating fluidized bed (CFB) reactor. In another embodiment, the coal fired reactor can be a pulverized coal (PC) reactor.

In still another embodiment of the present invention, emissions from a coal fired reactor can be treated using a system of at least two dry scrubbers configured to treat flue gas in series. As mentioned above, suitable dry scrubbers can include any known dry scrubber technology. Non-limiting examples of such dry scrubbers include spray dryer absorber, flash dryer absorber, dry sorbent injector, fluidized bed absorber, circulating dry scrubber, and combinations thereof. In one aspect, the system for treating flue gas from a coal fired reactor can include a first dry scrubber operatively connected to the coal fired reactor and configured for treating flue gas therefrom to produce a treated flue gas. Further, a second dry scrubber can be operatively connected to the first dry scrubber and configured for additional treatment of the treated flue gas to produce a low sulfur flue gas. In one detailed aspect, the first dry scrubber is a dry sorbent injector and the second dry scrubber is a spray dryer absorber. Such a double dry scrubbing system can be operatively connected to a variety of coal fired reactors. However, in one embodiment of the present invention, the coal fired reactor can be a circulating fluidized bed.

Similar considerations and factors can influence the amount of contaminants removed from the flue gas, as discussed above in connection with wet scrubbing systems. However, in one aspect, the systems and methods of the present invention can be adapted to reduce sulfur oxide emissions by from about 95% to about 100%, and in another embodiment can reduce sulfur oxide emissions by from about 99% to about 100%.

The following examples illustrate exemplary embodiments of the invention. However, it is to be understood that the following is only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what is presently deemed to be practical embodiments of the invention.

### EXAMPLES

### Example 1

A 250 MWe (net) CFB reactor, firing 3% sulfur Eastern Bituminous coal, is retrofitted with a wet scrubber. The total gas weight exiting the boiler is about 2,543,000 lb/hr. Providing limestone sufficient to achieve a 90% reduction in SO₂ from the CFB results in production of about 2089 lb/hr (about 261 ppm) of SO₂. The wet scrubber is a spray tower absorber which reduces the quantity of SO₂ exiting the wet scrubber to about 80 lb/hr (10 ppm). This system provides an overall SO₂ reduction of about 99.6%. Such a reduction eliminates about 7,920 tons of SO₂ per year.

### Example 2

A 400 MWe (net) PC reactor, firing 1% sulfur western bituminous coal having a standard baghouse for particulate removal, is retrofitted with a double wet scrubber. The total gas weight exiting the boiler is about 4,660,000 lb/hr. With no SO₂ reduction system, SO₂ emissions from the boiler outlet are about 11,700 lb/hr. The wet scrubbers are a combination of a spray tower absorber and a mobile bed scrubber which reduces the quantity of SO₂ exiting the wet scrubbers to about 117 lb/hr. This system provides an overall SO₂ reduction of about 99%. Such a reduction eliminates about 46,120 tons of SO₂ per year.

Thus, there is disclosed improved systems and methods for treatment of flue gas from coal fired reactors. The above description and examples are intended only to illustrate certain potential uses of this invention. It will be readily understood by those skilled in the art that the present invention is applicable to a broad range of utility and industrial applications. Many embodiments and adaptations of the present invention other than those herein described, as well as many variations, modifications and equivalent arrangements will be apparent from or reasonably suggested by the present invention and the forgoing description thereof without departing from the substance for scope of the present invention. Accordingly, while the present invention has been described herein in detail in relation to its preferred embodiment, it is to be understood that this disclosure is only illustrative and exemplary of the present invention and is made merely for purpose of providing a full and enabling disclosure of the invention. The forgoing disclosure is not intended or to be construed to limit the present invention or otherwise to exclude any such other embodiment, adaptations, variations, modifications and equivalent arrangements, the present invention being limited only by the claims appended hereto and the equivalents thereof.

1. A system for treatment of flue gas from a coal fired circulating fluidized bed comprising:
a selective catalytic reduction system (SCR) operatively connected to the circulating fluidized bed such that the SCR system reduces nitrogen oxide compounds in the flue gas to produce a low nitrogen oxide flue gas; and
a wet scrubber operatively connected to the SCR and configured for treating the low nitrogen oxide flue gas.

2. The system as in claim 1, further comprising an additional wet scrubber operatively connected downstream of the wet scrubber to produce a low sulfur oxide flue gas.

3. The system as in claim 1, wherein the wet scrubber is a member selected from the group consisting of gas phase scrubber, liquid phase scrubber, and combinations thereof.

4. The system as in claim 3, wherein the wet scrubber is a combination liquid-gas phase scrubber, selected from the group consisting of packed tower scrubber, wet film scrubber, cyclonic spray scrubber, mobile or moving bed absorber, and baffle spray absorber.

5. The system as in claim 3, wherein the wet scrubber is a gas phase scrubber, selected from the group consisting of venturi scrubber, plate tower scrubber, and orifice scrubber.

6. The system as in claim 1, wherein the system of treating flue gas includes a selective non-catalytic reduction (SNCR) system operatively connected between the circulating fluidized bed and the SCR system.

7. The system as in claim 1, wherein the SCR system includes an ammonia or urea injection system and a catalyst.

8. The system as in claim 1, wherein a particulate collection system is operatively connected between the circulating fluidized bed and the wet scrubber.

9. The system as in claim 1, wherein the low nitrogen oxide flue gas has about 65 to about 85 percent reduction of nitrogen oxide from the flue gas.

10. The system as in claim 9, wherein the low nitrogen oxide flue gas has about 95 to about 99 percent reduction of nitrogen oxide from the flue gas.

11. A system for treatment of a flue gas from a pulverized coal reactor, comprising:
a selective non-catalytic reduction (SNCR) system operatively connected to the pulverized coal reactor such that the SNCR system reduces nitrogen oxide compounds to produce a low nitrogen oxide flue gas.

12. The system as in claim 11, wherein the pulverized coal reactor includes a low nitrogen oxide burner.

13. The system as in claim 11, further comprising an SCR system operatively connected downstream of the SNCR.

14. The system as in claim 11, further comprising a dry scrubber operatively connected downstream of the pulverized coal reactor and the SNCR system.

15. The system as in claim 14, wherein the dry scrubber is selected from the group consisting of a spry dryer absorber, flash dryer absorber, dry sorbent injectors, and combinations thereof.

16. The system as in claim 14, further comprises a wet scrubber operatively connected to the dry scrubber.

17. The system as in claim 11, wherein the SNCR system includes an ammonia or urea injection unit.

18. The system as in claim 11, wherein the low nitrogen oxide flue gas has about 93 to about 96 percent reduction of nitrogen oxide from the flue gas.

19. The method of decreasing nitrogen oxide emissions from a circulating fluidized bed comprising the steps of:
treating the flue gas with an SCR to produce a low nitrogen oxide flue gas; and
treating the low nitrogen oxide flue gas with a wet scrubber to produce a low sulfur oxide flue gas.

20. The method of claim 19, further comprising the step of:
treating the low sulfur oxide flue gas with an additional wet scrubber to produce an ultra-low sulfur oxide flue gas.

21. The method of claim 19, further comprising an SNCR operatively connected between the SCR and the circulating fluidized bed.

22. The method of claim 19, further comprising the step of treating the flue gas to obtain from about 95 to about 99 percent reduction of nitrogen oxide in the flue gas.

23. A method of decreasing nitrogen oxide emissions in a flue gas from a pulverized coal reactor comprising the steps of:
treating the flue gas with an selective non-catalytic reduction (SNCR) system to produce a low nitrogen oxide flue gas.

24. The method of claim 23, further comprising the step of:
treating the low nitrogen oxide flue gas with an SCR system to further reduce the nitrogen oxide in the low nitrogen oxide flue gas.

25. The method of claim 23, wherein the SNCR system is an ammonia injection unit.

26. The method of claim 23, further comprising the step of:
treating the low nitrogen oxide flue gas with a dry scrubber to produce a low sulfur flue gas.

27. The method of claim 26, further comprising the step of:
treating the low sulfur oxide flue gas with a wet scrubber to produce an ultra-low sulfur oxide flue gas.

28. The method of claim 23, wherein the low nitrogen oxide flue gas has about 93 to about 96 percent reduction of nitrogen oxide from the flue gas.
